(19) United States
(12) Patent Application Publication
(10) Pub. No.: US 2006/0242204 A1
(43) Pub. Date: Oct. 26, 2006

(54) Sync manager conflict resolution

(75) Inventors: Benjamin J. Karas, Bellevue, WA (US); Brian S. Aust, Redmond, WA (US); Kenneth W. Parker, Bellevue, WA (US); Mark McCabe, Duvall, WA (US); Mohammed A. Samji, Bellevue, WA (US); Rebecca J. Deutsch, Seattle, WA (US); David Potter, Bothell, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/111,733

(22) Filed: Apr. 22, 2005

(51) Int. Cl. G06F 17/30

(52) U.S. Cl. 707/200

(57) ABSTRACT

A system and method are provided for implementing conflict resolution in a sync manager. In case of a conflict, the sync operation creates and stores a conflict object, and resumes the sync operation without requiring user input. The sync operation can thus be completed without user input and the user may choose to resolve outstanding conflicts, either on-line or off-line, at a convenient time. Furthermore, the invention provides a platform for developing standardized, user-friendly sync operations. In addition, the invention presents a centralized location that allows a user to quickly and easily resolve conflicts originating from many devices.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to a system and method for content resolution and in particular to a system and method for providing user-friendly content resolution within a sync manager.

### BACKGROUND OF THE INVENTION

Computer users in today's environment may use a number of different computing devices. For example, a computer user may use a stationary computer terminal, a laptop computer, and a blackberry or other mobile device. Often, these computing devices are used to store similar or related information. For example, a calendar storing a user's appointment schedule may be present on a stationary computer terminal, a laptop computer, and a mobile device. As another example, a document may be stored on a stationary computer terminal and then copied to a laptop computer, where a user may edit the document.

After updating or altering information on one device, the user may wish to transfer the updated information to another device. For example, after entering a new appointment into a calendar stored on a mobile device, the user may wish to transfer the new information to a calendar stored on a computer terminal. As another example, after editing a document on a laptop computer, the user may wish to transfer the edited document to a stationary computer. Other examples exist.

In order to transfer information between devices, the user may choose to synchronize, or “sync,” two or more devices. One or more of the devices may contain a “sync manager,” which performs syncing operations. When two devices are synced, it is typically determined which device contains the most recent information. The device with the most recent information may, for example, transfer information to the other device.

Syncing is also useful in networking applications. For example, two or more users may have access to the same document, calendar, or other information in a networked computing environment. Syncing may be used in such an environment to ensure that the most recent copy of the information is used.

When more than one version of the information exists, the sync manager will typically attempt to determine which version is the most recent. For example, after performing a sync operation between a mobile device and a stationary computer terminal, a user may enter a new appointment into a calendar on the mobile device. As another example, after performing a sync operation between a laptop computer and a stationary computer terminal, a user may make changes to the document on the laptop computer. In many cases, the sync manager may decide which version of information to keep without any user input. For example, the sync manager may determine which version of the information has been most recently edited, and keep only the most recent version.

However, in some cases, it may not always be apparent which version of the information should be kept. Such a situation is known as a conflict. A conflict may occur, for example, when more than one version of the information has been edited since the last sync operation. For example, after performing a sync operation between a mobile device and a stationary computer terminal, a user may enter one new appointment into a calendar on the mobile device, and enter another new appointment into a calendar on the stationary computer terminal. As another example, after performing a sync operation between a laptop computer and a stationary computer terminal, a user may make changes to the document on the laptop computer, and make different changes to the document on the stationary computer terminal.

In the case of a conflict, the user will typically be prompted to enter input used to resolve the conflict. For example, the user may be asked whether to keep a first version of the information, keep a second version of the information, keep both versions by renaming one, or resolve the conflict by hand. If the user elects to resolve the conflict by hand, the user may, for example, be presented with further options, such as being presented with a list of discrepancies and being asked how to resolve each. For example, the user may be asked whether to keep or delete a first appointment entered into a handheld device, and may be asked whether to keep or delete a second appointment entered into a stationary computer terminal. As another example, a user may be presented with a list of changes made to a document via a laptop computer and a list of changes made to a document via a stationary computer terminal, and asked whether to keep or delete each change.

The process of determining which file(s) to keep, whether performed automatically or with user input, may be known as reconciling the files. In some cases, a conflict may occur in reconciling files. In this case, user input is typically required to reconcile the files. In other cases, no conflict occurs in reconciling files, for example, because only one version of the file has been edited since the last sync operation, or because no versions of the file have been edited since the last sync operation. In this case, no user input is typically required in reconciling the files.

Conventionally, a user may connect a first device to a second device to begin a sync operation. For example, a user may rest a handheld device in a cradle which is connected to a computer terminal, may connect a laptop computer to a stationary computer terminal, or the like. The sync manager then begins to reconcile the different versions of the document. In some instances, the sync manager may reconcile versions of the document without user input, such as by determining which version of information has been most recently edited. In other instances, the sync manager is not able to reconcile versions of the document without user input, and a conflict occurs.

When the sync manager encounters a conflict, the sync manager will, for example, halt the sync operation and prompt the user for input. The user may then be required provide input to resolve the conflict before the sync operation is resumed.

Because the user may be required to provide input before the sync operation is resumed, the user may find the sync operation to be time-consuming and demanding. There is therefore a need in the art for a sync operation that does not require immediate user input.

Furthermore, because each device may include its own sync manager, the user interfaces and methods for conflict resolution may vary greatly from device to device. This may result in a disruptive or confusing experience for the user. There is therefore a need for a standardized sync operation.

In addition, because the user may be required to sync each device in turn and provide input for each sync operation, syncing more than one device may prove cumbersome and tiresome for the user. There is therefore a need in the art for a centralized location that allows a user to quickly and easily resolve conflicts originating from many devices.

### BRIEF SUMMARY OF THE INVENTION

Embodiments of the present invention include a method for performing a sync operation. The method may include receiving a first file, receiving a second file, and determining if a conflict exists between the first file and the second file. The method may further include, if a conflict does not exist, reconciling the first file and the second file, and if a conflict does exist, creating a conflict object identifying the first file and the second file and specifying at least one method to resolve the conflict.

In a further aspect of the invention, a method for performing conflict resolution may include receiving a selection from a user indicating that conflict resolution is to begin, displaying first file information describing a first file, displaying second file information describing a second file, and displaying at least one conflict resolution option, each conflict resolution option identifying a possible method of resolving the conflict.

In still further aspects of the invention, a system for performing a sync operation may include a sync manager configured to compare a first file and a second file, determine whether a conflict exists between the first file and the second file, reconcile the first file and the second file if a conflict does not exist, and create a conflict object if a conflict does exist. The system may further include a conflict store configured to hold conflict objects and a resolver specifying at least one method to resolve a conflict.

The foregoing systems and methods may enable a sync operation that does not require immediate user input, but rather allows the user to resolve outstanding conflicts, either on-line or off-line, at a convenient time. Furthermore, the systems and methods of the present invention may provide a platform for developing standardized, user-friendly sync operations. In addition, systems and methods of the present invention may present a centralized location that allows a user to quickly and easily resolve conflicts originating from many devices.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is block diagram illustrating a computerized environment in which embodiments of the invention may be implemented;

FIG. 3 is a flow chart illustrating a method for performing a sync operation in accordance with an embodiment of the invention;

FIG. 4 is a flow chart illustrating a method for performing conflict resolution in accordance with an embodiment of the invention; and

FIGS. 5-6 display exemplary graphical user interface (GUI) windows in accordance with an embodiment of the invention.

### DETAILED DESCRIPTION OF THE INVENTION

I. System Overview

A system and method are provided for implementing a conflict resolution manager. The conflict resolution manager may be used to resolve conflicts that arise during a sync operation.

The system may include a terminal 200, which includes a sync manager 201. The terminal 200 may be connected to one or more devices 202, 204 via couplings 206, 208, respectively. Each device 202, 204 may be or include, for example, a mobile communication device, a laptop computer, a gaming device, a camera, a computer terminal, or the like. The device 202 may include one or more files 210a, 212a, and the device 204 may include one or more files 214a, 216a. The files 210a, 212a, 214a, 216a may be, for example, versions of files 210b, 212b, 214b, 216b, stored on terminal 200, respectively. The files 210a, 212a, 214a, 216a may therefore be identical to or be similar to files 210b, 212b, 214b, 216b, respectively.

A sync operation may begin, for example, when a user connects the device 202 to the terminal 200 via the coupling 206 and/or connects the device 204 to the terminal 200 via the coupling 208. At this point, the sync manager 201 attempts to reconcile the files 210a, 212a stored in device 202 with the files 210b, 212b stored in the terminal 200; and/or attempts to reconcile the files 214a, 216a stored in device 204 with the files 214b, 216b stored in the terminal 200.

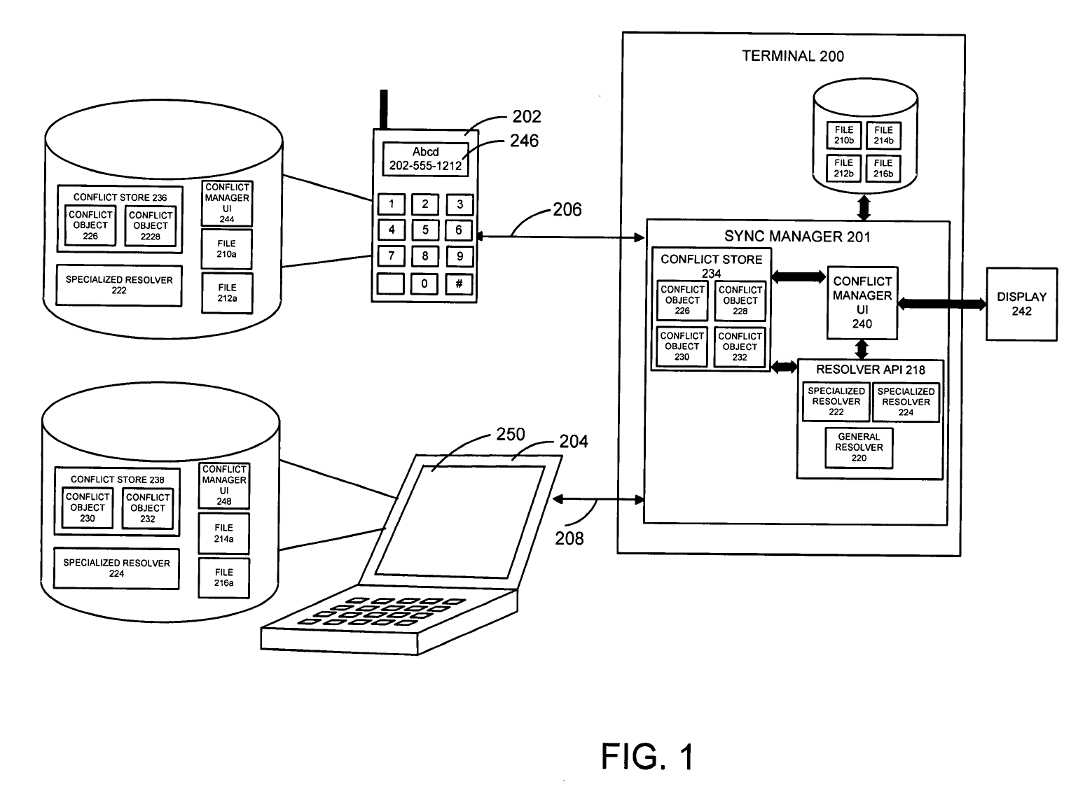

The sync manager 201 contains a resolver Application Program Interface (API) 218 that contains methods used to reconcile files. The resolver API 218 may include a general resolver 220, for example, which is the default resolver used to reconcile files. The resolver API 218 may also be or include an extensible API that is extended, for example, to create specialized resolvers for particular devices and/or applications. As a particular example, Word developers can write a conflict manager that allows users to resolve a conflict between Word documents. As shown in FIG. 1, specialized resolver 222 may be an extension of the resolver API 218 that is used to reconcile files from the device 202. Specialized resolver 222 may be stored, for example, on the terminal 200, in the device 202, or in both locations. As another example, specialized resolver 224 may be an extension of the resolver API 218 that is used to reconcile files of a particular file type, such as files created in a particular application. Specialized resolver 224 may be stored, for example, on the terminal 200, in the device 204, or in both locations.

When a sync operation is performed, the sync manager 201 reconciles the files 210a, 212a with the files 210b, 212b and/or reconciles the files 214a, 216a with the files 214b, 216b. If a specialized resolver 222 or 224 has been defined to handle the particular file reconciliation underway, the specialized resolver 222 or 224 may be used. If no specialized resolver 222 or 224 has been defined to handle the particular file reconciliation underway, the general resolver 220 may be used. In other cases, the sync manager 201 may reconcile the files without any resolver.

The sync manager 201 performs file reconciliation, for example, using methods provided within the sync manger 201 and/or using methods provided in resolvers 220, 222, and/or 224. If the sync manager 201 is able to determine which version of a file to keep, the sync manager 201 performs the file reconciliation automatically, for example, by keeping the most recent version of a document. If the sync manager 201 is not able to determine which version of a file to keep, a conflict occurs.

When a conflict occurs, the sync manager 201 creates a conflict object 226, 228, 230, 232. Each conflict object 226, 228, 230, 232 contains information specifying the conflict between two files. For example, conflict object 226 may contain information specifying a conflict between files 210a and 210b, conflict object 228 may contain information specifying a conflict between files 212a and 212b, conflict object 230 may contain information specifying a conflict between files 214a and 214b, and conflict object 232 may contain information specifying a conflict between files 216a and 216b.

Information contained in the conflict objects 226, 228, 230, 232 may include, for example, information specifying the file(s) in conflict, when the conflict occurred, and the device involved in the conflict. Information contained in the conflict object 226, 228, 230, 232 may further include, for example, information identifying the two files in conflict, or copies of the files in conflict. Information contained in the conflict object 226, 228, 230, 232 may also include, for example, information specifying the resolver 220, 222, or 224 used to resolve the conflict.

The conflict objects 226, 228, 230, 232 may be stored, for example, in a conflict store 234 within the terminal 200. Optionally, some or all of the conflict objects 226, 228, 230, 232 may also be stored on the device 202 and/or the device 204. The device 202 and/or the device 204 may contain, for example, conflict stores 236, 238, respectively, to store the conflict objects 226, 228, 230, 232.

When a conflict occurs during the sync operation, the sync manager 201 creates a conflict object 226, 228, 230, 232, and resumes the sync operation. In embodiments of the invention, no user input is necessary during the sync operation.

The sync manager 201 may include a conflict manager user interface (UI) 240 and a display 242. When one or more conflicts are detected, the conflict manager UI may so indicate via the display 242, for example, using an icon in the system tray or any other appropriate means. At a convenient time, the user may elect to resolve outstanding conflicts, for example, by double-clicking on the icon.

When the user elects to resolve outstanding conflicts, the conflict manager UI 240 presents a list of outstanding conflicts to the user via the display 242. The list of outstanding conflicts includes, for example, a list entry for each conflict object 226, 228, 230, 232 in the conflict store 234. For each list entry, the user may elect to resolve the conflict, for example, by double-clicking the list entry. The user is then prompted to resolve the conflict, for example, using the resolver 220, 222, or 224 specified in the conflict object 226, 228, 230, or 232.

The conflict manager UI 240 may present the user with several resolution options via the display 242. The resolution options presented to the user are specified by the resolver 220, 222, or 224. Resolution options may include, for example, the option to keep the first version of the file, the option to keep the second version of the file, the option to keep both versions by renaming one, the option to resolve discrepancies by hand using a particular application, and/or any other resolution options specified by the resolver 220, 222, or 224.

The user may resolve one or more conflicts, and may choose to save the remaining conflicts to resolve at a later time. In implementations of the present invention, the user is not required to make decisions about conflict resolution at any particular time.

In addition, the user may elect to resolve conflicts at a time when the devices 202, 204 are not connected to the device 200. The user selects from the presented resolution options, and at the time of the next sync operation, the user's selections will be implemented to resolve the conflicts.

In implementations of the present invention, a user, such as, for example, an administrator of a system, may provide input specifying in advance how particular types of conflicts are to be resolved. Providing such input may be known as creating a “conflict policy” for a particular type of conflict. When a conflict is detected and a conflict policy for handling the particular type of conflict exists, the system may resolve the conflict in accordance with the policy, for example, without requiring user input. As one particular example, an administrator of a system may create a conflict policy by specifying that, for Word documents in a particular folder, both versions of a file should be kept, and the names of both files should be changed by appending the terms “v1” and “v2” to the file names. When a conflict between Word documents occurs in this folder, the conflict will be resolved, for example, in accordance with the conflict policy and without user input.

Furthermore, the device 202 may optionally include a conflict manager UI 244 used to present the user with resolution options via a display 246 on the device 202, and the device 204 may optionally include a conflict manager UI 248 used to present the user with resolution options via a display 250 on the device 204. Selections made by the user on the devices 202, 204 may be implemented at the time of the next sync operation.

II. Exemplary Operating Environment

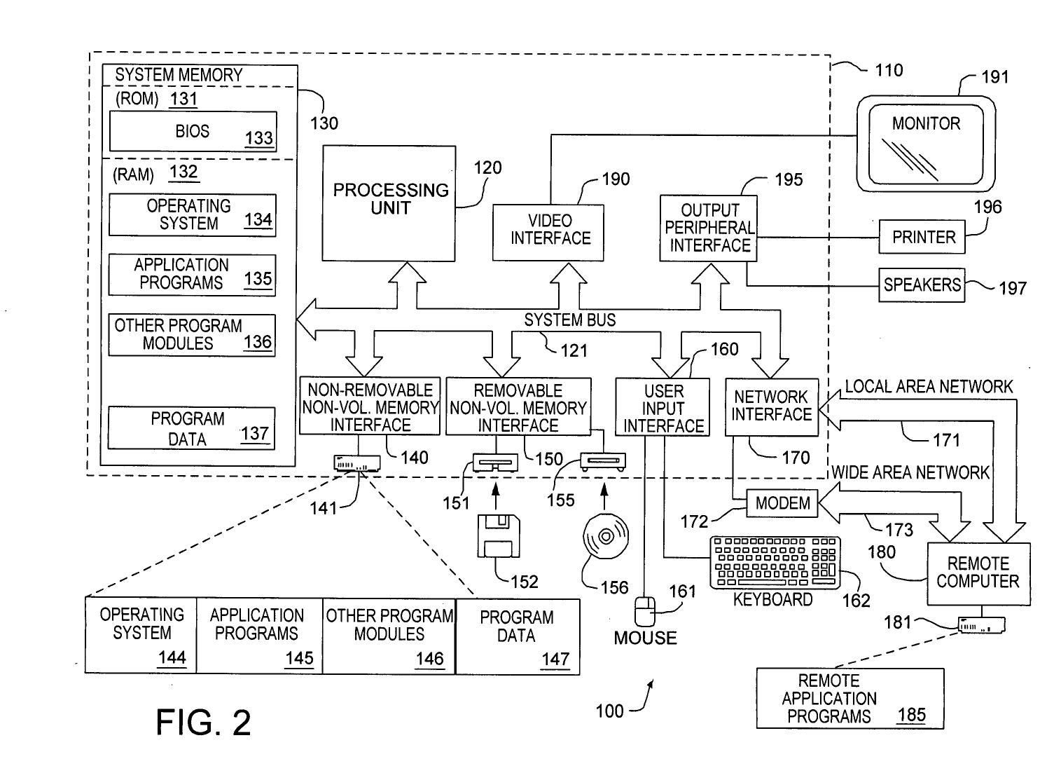

FIG. 2 illustrates an example of a suitable computing system environment 100 on which the system for conflict resolution may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. Systems and Methods of the Invention

As set forth above, FIG. 1 illustrates a system for implementing sync manager including conflict resolution functionality, in accordance with an embodiment of the invention. As described above with respect to FIG. 2, the system may include one or more user computers.

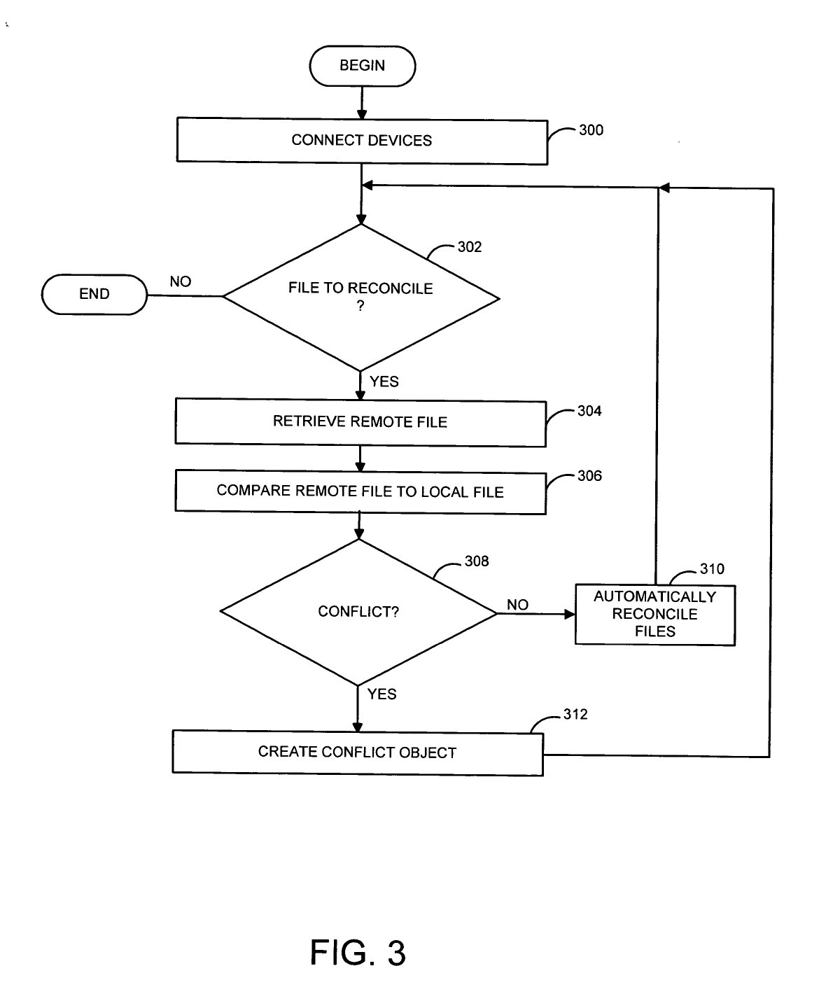

FIG. 3 is a flow chart illustrating a method for performing a sync operation in accordance with an embodiment of the invention. As shown in FIG. 3, a user may begin by connecting two or more devices 300. Connecting two or more devices 300 may include, for example, connecting a mobile device to a stationary computer terminal, connecting a computer terminal to a network, or performing any other similar connection. The remainder of the method may take place, for example, on one of the connected devices. However, in other implementations, the method takes place on two or more devices.

The method continues in step 302, wherein it is determined whether the connected devices contain any files to reconcile. If there are no further files to reconcile, the method may end.

If there are files to sync, in step 304, a file may be retrieved, for example, from a remote device. In step 306, the retrieved file may be compared to a local file. The local file is, for example, a version of the retrieved file, and as such, may be similar or identical to the retrieved file.

In step 308, it is determined whether there is a conflict between the retrieved file and the local file. If there is no conflict, no user input is required, for example, to reconcile the files. This may be the case, for example, if the files are identical or if only one of the files has been edited since the last sync operation. If there is no conflict, the files may be automatically reconciled in step 310, and the method may return to step 302, wherein it is determined whether there are further files to reconcile.

If it is determined in step 308 that there is a conflict, a conflict object may be created in step 312. The created conflict object may be, for example, a conflict object as described above with reference to FIG. 1. The conflict object contains information, for example, that will be used to resolve the conflict at a later time. The conflict object may be stored in one or more conflict stores. The method then continues in step 302, wherein it is determined whether there are any further files to reconcile.

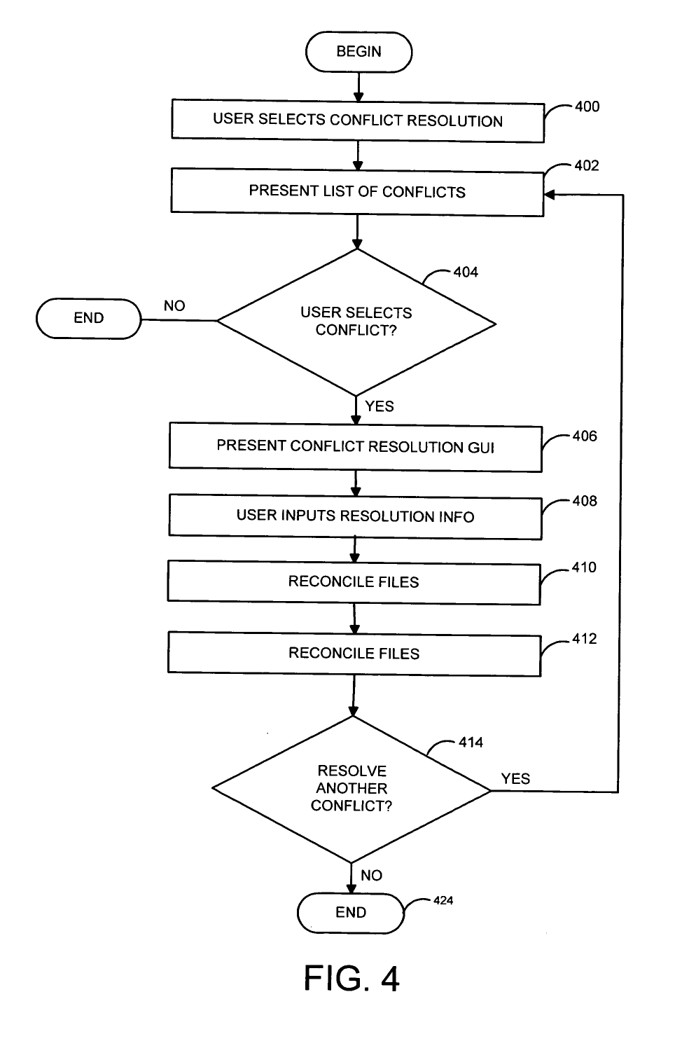

FIG. 4 is a flow chart illustrating a method for performing conflict resolution in accordance with an embodiment of the invention. As shown in FIG. 4, the method may begin in step 400, wherein a user may select to resolve conflicts, for example, by double-clicking an icon in the system tray or by some other appropriate method. In step 402, the user may be presented with a list of outstanding conflicts. The list of outstanding conflicts may be, for example, a list of all the conflict objects in a conflict store, and may represent all the conflicts that have yet to be resolved.

In step 404, the user may select a conflict from the list of conflicts, for example, by double-clicking on a conflict or by some other appropriate method. Alternatively, the user may decline to select a conflict and may choose instead to terminate conflict resolution. If the user elects to terminate conflict resolution, the conflict objects in the conflict store may be unchanged, and the user may resolve any outstanding conflicts in the conflict store at a later time.

If the user selects a conflict from the list of conflicts in step 404, the user is presented with a GUI. The GUI may be presented, for example, by a conflict manager UI. The conflict manager UI may, for example, query a conflict object to determine which resolver is appropriate to resolve the conflict. The GUI presented to the user may contain, for example, one or more options for resolving the conflict, as specified by the appropriate resolver. For example, a user may be asked whether to keep one version of a file, keep a second version of the file, keep both versions by renaming one, resolve the conflicts by hand using a particular application, or perform some other form of conflict resolution specified by the resolver.

In step 410, the files are reconciled in the manner specified by the user. In step 412, the conflict object representing the conflict is removed from the conflict store. This may include, for example, deleting the conflict object, marking the conflict object completed, or some other appropriate method. Removing the conflict from the conflict store indicates that the conflict has been resolved.

In step 414, the user may be presented with the option to resolve another conflict. If the user does not wish to resolve another conflict, the method may end. If the user wishes to resolve another conflict, the method may return to step 402, wherein the user may be presented with a list of outstanding conflicts.

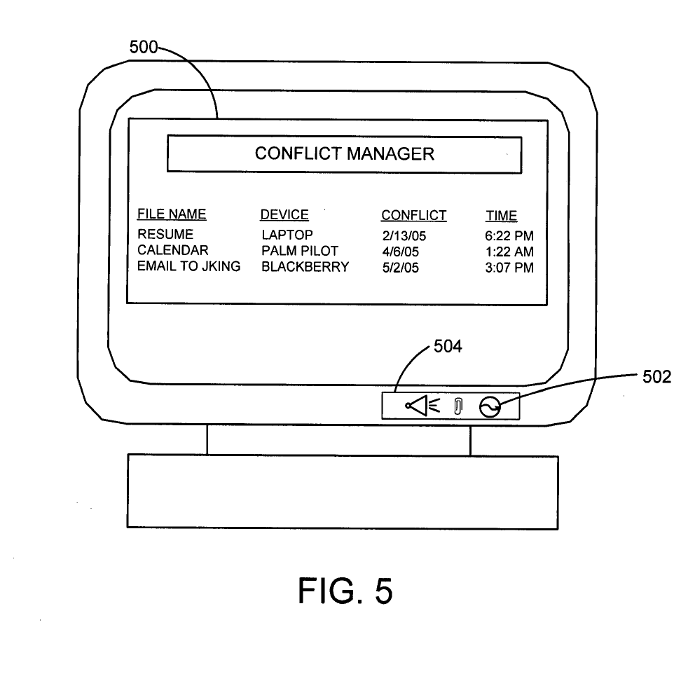

FIG. 5 shows an exemplary GUI window 500 that may be displayed to a user in accordance with an embodiment of the invention. As shown in FIG. 5, a user may be alerted to the fact that there are outstanding conflicts, for example, via an icon 502 in a system tray 504. For example, the icon 502 may be displayed in a particular color, signaling that there are outstanding conflicts. The user may invoke a conflict manager, for example, by double-clicking on the icon 502 or by some other appropriate method.

When the user invokes the conflict manager, the user may be presented with a conflict manager GUI screen 500, as shown in FIG. 5, which may be implemented, for example, as a dialog box. The conflict manager GUI screen 500 may present a list of outstanding conflicts. For each outstanding conflict, the conflict manager GUI screen 506 may display information identifying the conflict, such as, for example, the name of the file(s) in conflict, the device involved in the conflict, the time the conflict was detected, the time of the most recent edit to one of the files in conflict, or any other relevant information.

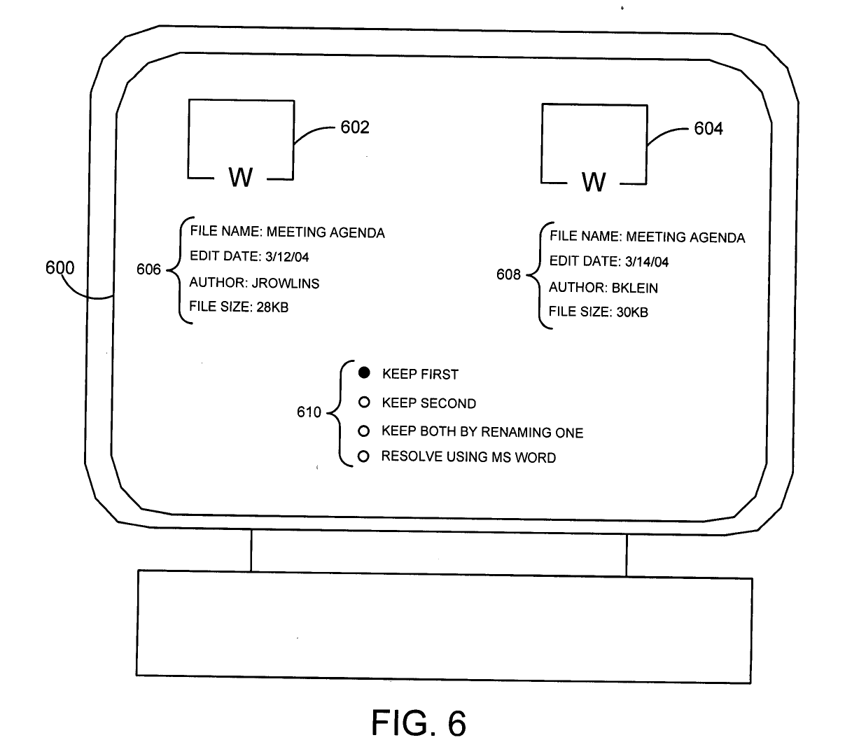

If the user wishes to resolve a conflict, the user so indicates, for example, by double-clicking on a conflict in the list of conflicts or by some other appropriate method. The user may then be presented with the conflict resolution GUI screen 600 of FIG. 6.

FIG. 6 shows an exemplary GUI window 600 that may be displayed to a user in accordance with an embodiment of the invention. As shown in FIG. 6, a user wishing to resolve a particular conflict may be presented with the GUI window 600, which may be implemented, for example, as a dialog box. The GUI window 600 may display information about the two files in conflict. Furthermore, the GUI window 600 may display various options for resolving the outstanding conflict, as specified by a resolver.

For example, the GUI window 600 may display a first icon 602 representing the first version of the file and a second icon 604 representing the second version of the file. If the user desires to view either of the files, the user may do so, for example, by double-clicking on the first icon 602 or the second icon 604. The GUI window 600 may also display information 606 describing the first file and information 608 describing the second file. Some or all of the information 606 and 608 may be dynamically chosen, for example, to display differences between the first file and the second file. For example, if it is determined that the first file 606 and the second file 608 have different authors, author information may be displayed for each of the files. Thus, the user may be presented with information that will be helpful in determining how to resolve the conflict.

Furthermore, the GUI window 600 may present the user with one or more options 610 for resolving the conflict. The options 610 presented to the user may be, for example specified by a resolver. The user may choose, for example, to keep the first version of the file, to keep the second version of the file, to keep both versions by renaming one, or to resolve the file using a specialized method. The specialized methods displayed in the GUI window 600 may be, for example, methods specified in the resolver, and may be specific to a particular device or specific to a certain application or file type, such as being specific to Word documents.

If the user selects to keep the first version or to keep the second version, the conflict resolution may be performed, for example, without any further user input. If the user selects to keep both versions by renaming one, the user may be presented, for example, by renaming one of the files within the GUI window 600, such as by right-clicking one of the icons 602, 604, or by some other appropriate means. If the user selects to resolve the conflict using a specialized method as specified by the resolver. As a particular example, resolving a conflict using MS Word may involve, for example, presenting a user with a Word document containing highlighted changes or discrepancies, and prompting the user to accept or reject each change or discrepancy.

The GUI windows described in FIGS. 5-6 are merely illustrative and are not intended to limit the invention. Other user interfaces are possible and are within the scope of the invention. For example, it is contemplated that the user interface for conflict resolution may be implemented as a “wizard”-type interface, such that one window frame may be used to display each conflict in turn, and such that the user may navigate through the conflicts using “forward” and “back” buttons. Other interfaces are possible.

While particular embodiments of the invention have been illustrated and described in detail herein, it should be understood that various changes and modifications might be made to the invention without departing from the scope and intent of the invention. For example, while the invention has primarily been described in terms of mobile devices connecting to a stationary computer terminal, the invention is equally suited to other environments, such as a network of computer terminals or other appropriate environment. In addition, while the devices have been described as being connected via couplings, any method of communication, such as, for example, wireless communication, is suitable. The embodiments described herein are intended in all respects to be illustrative rather than restrictive. Alternate embodiments will become apparent to those skilled in the art to which the present invention pertains without departing from its scope.

Furthermore, while the invention has been described in terms of resolving a conflict between two files or otherwise reconciling two files, it is within the scope of the invention to reconcile three or more files. Such a situation may arise, for example, when three or more users have each altered the same or similar files, or in other circumstances. In the case of a n-way conflict, with n being an integer greater than two, the system will select an appropriate resolver and user interface to reconcile the files. A GUI presented to a user in n-way conflict resolution may display, for example, the two latest versions of the file in conflict, and allow the user to select an option to view older versions of the file in conflict.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for performing a sync operation, the method comprising:
receiving a first file;
receiving a second file;
determining if a conflict exists between the first file and the second file;
if a conflict does not exist, reconciling the first file and the second file; and
if a conflict does exist, creating a conflict object identifying the first file and the second file and specifying at least one method to resolve the conflict.

2. The method of claim 1, further comprising receiving conflict resolution input from a user at a time selected by the user.

3. The method of claim 1, wherein the first file is received from an external device.

4. The method of claim 1, the second file is received from an external device.

5. The method of claim 1, wherein the first file is received via a network.

6. The method of claim 1, wherein the second file is received from local storage.

7. The method of claim 1, wherein determining if a conflict exists between the first file and the second file comprises determining whether both the first file and the second file have been altered since a most recent sync operation.

8. The method of claim 1, wherein reconciling the first file and the second file comprises one of the group consisting of replacing the first file with the second file, replacing the second file with the first file, and creating a third file based on the first file and the second file.

9. The method of claim 1, further comprising resolving at least one conflict in accordance with a conflict policy.

10. A method for performing conflict resolution, the method comprising:
receiving a selection from a user indicating that conflict resolution is to begin;
displaying first file information describing a first file;
displaying second file information describing a second file; and
displaying at least one conflict resolution option, each conflict resolution option identifying a possible method of resolving the conflict.

11. The method of claim 10, further comprising displaying a list of one or more conflicts.

12. The method of claim 11, further comprising receiving a user selection of one conflict to resolve, selected from the list of conflicts.

13. The method of claim 10, further comprising receiving a user selection of one conflict resolution option.

14. The method of claim 13, further comprising resolving the conflict in accordance with the user-selected conflict resolution option.

15. The method of claim 10, wherein the first file information and the second file information are selected based on differences between the first file and the second file.

16. The method of claim 10, wherein each conflict resolution option is specified in a resolver, the resolver being implemented in accordance with a resolver application program interface.

17. A system for performing a sync operation, comprising:
a sync manager configured to compare a first file and a second file, determine whether a conflict exists between the first file and the second file, reconcile the first file and the second file if a conflict does not exist, and create a conflict object if a conflict does exist;
a conflict store configured to hold conflict objects; and
a resolver specifying at least one method to resolve a conflict.

18. The system of claim 17, wherein the sync manager is configured to compare n files, n being an integer greater than or equal to 2; determine whether a conflict exists between the n files, reconcile the n files if a conflict does not exist, and create a conflict object if a conflict does exist.

19. The system of claim 17, wherein the resolver is implemented in accordance with an extensible resolver application program interface.

20. The system of claim 17, further comprising a conflict manager user interface configured to display conflict information received from a conflict object.
